(19) United States
(12) Patent Application Publication
(10) Pub. No.: US 2008/0011342 A1
(43) Pub. Date: Jan. 17, 2008

(54) Dish washing machine

(75) Inventors: Jung Chan Ryu, Suwon-si (KR); Sung Jin Kim, Suweon-si (KR); Yong Woon Han, Gunpo-si (KR); Young Ho Kwon, Seongnam-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/645,714

(22) Filed: Dec. 27, 2006

(30) Foreign Application Priority Data
Jul. 12, 2006 (KR) 10-2006-0065594

(51) Int. Cl. B08B 3/00

(52) U.S. Cl. 134/57 DL; 134/56 D; 134/58 D

(57) ABSTRACT

A dish washing machine in which the size of a control panel can be increased and a user can conveniently manipulate the control panel and easily check operation state thereof. The dish washing machine includes a housing having an opening formed in a front side thereof, a door hinged to the front side of the housing to open and close the opening, and a control panel installed to the upper side of the door. The control panel is obliquely installed to the upper side of the door at a predetermined angle. Moreover, the control panel is installed to swing with respect to the door and to maintain a predetermined oblique angle regardless of the opening and closing of the door so that the user can conveniently check and manipulate the control panel.

### CROSS-REFERENCE TO RELATED APPLICATIONS

This application claims the benefit of Korean Patent Application No. 10-2006-0065594, filed on Jul. 12, 2006, in the Korean Intellectual Property Office, the disclosure of which is incorporated herein by reference.

### BACKGROUND OF THE INVENTION

1. Field of the Invention

The present invention relates to a dish washing machine. More particularly, to a dish washing machine in which a control panel is obliquely disposed on the upper side of a door of the dish washing machine, at a predetermined angle to increase an area of the control panel and the door downwardly rotates and is opened by a predetermined angle to conveniently manipulate the control panel and to check the operation of the dish washing machine.

2. Description of the Related Art

A conventional dish washing machine includes a washing pump, a plurality of jet nozzles, and a washing water pipe to connect the washing pump to the jet nozzles, which are installed in a tub, in which dishes are washed, and high pressure jet washing water is supplied to the dishes accommodated in a dish basket to wash the dishes.

In the conventional dish washing machine, a control panel having a manipulation unit and a display, is installed such that a user can manipulate the control panel according to a quantity and a type of the dishes to select a washing process and washing time.

In order improve an external appearance of the conventional dish washing machine, a conventional dish washing machine whose control panel is not exposed to outside of the machine is is disclosed in Korean Patent Laid-Open No. 10-2005-0123259.

The conventional dish washing machine includes an opening formed in the front side of a housing to accommodate dishes, a door hinged to the front lower side of the housing and vertically pivoted to open the opening, and a control panel installed to the upper side of the door to control the dish washing machine.

Thus, when the door is closed, the upper side of the door is hidden in the opening of the housing and is not exposed so as to make an aesthetically pleasing appearance of the dish washing machine. In this state, when the door is opened downwardly for the operation of the dish washing machine, the control panel is exposed such that the user can manipulate the control panel to drive the dish washing machine in a desired dish washing process.

However, when the control panel is installed to the upper side of the door as described above, since the size of the control panel is restricted to the size of the upper side of the door, the control panel has a limit in construction thereof. Particularly, since the door is thin and the control panel must have a narrow width adequate to the thickness of the door, the sizes of the display and other various manipulation units of the control panel should be reduced. Thus, the user has a difficult time checking the display and manipulating the manipulation units.

Moreover, when the door is opened by a predetermined angle in order for the user to manipulate the control panel, since the control panel is obliquely positioned as much as the angle of the opened door, it is more difficult for the user to check the display of the control panel and it is very inconvenient to manipulate the various manipulation units of the control panel.

### SUMMARY OF THE INVENTION

Accordingly, it is an aspect of the present invention to provide a dish washing machine including a control panel having a wide area.

It is another aspect of the present invention to provide a dish washing machine in which manipulation and checking of an operation of a control panel are conveniently performed.

Additional aspects and/or advantages of the invention will be set forth in part in the description which follows and, in part, will be apparent from the description, or may be learned by practice of the invention.

The foregoing and/or other aspects of the present invention are achieved by providing a dish washing machine including a housing having an opening formed in a front side thereof, a door hinged to the front side of the housing to open and close the opening, and a control panel installed to an upper side of the door, the control panel obliquely installed to the upper side of the door at a predetermined angle.

The control panel is downwardly or upwardly oblique toward an inside of the housing.

The control panel is coupled with the door to swing by which hinge shafts formed in lateral upper sides of the control panel are inserted into hinge holes formed in lateral sides of the door.

A weight is installed in a lower side of the control panel to be a center of gravity of the control panel, and to allow the control panel to swing smoothly.

According to an aspect of the present invention, the control panel includes first and second planes which meet at centers thereof, and an arc surface to connect the first and second planes to each other, and an upper side of the door is formed by a concave arc surface corresponding to the arc surface of the control panel so that the arc surface of the control panel swings along the arc surface of the door.

Each of the hinge shafts is positioned adjacent to a center of the arc surface where the first and second planes meet and the weight is positioned adjacent to the second plane positioned in the door, such that the first plane maintains a state oblique at a predetermined angle regardless of an opening angle of the door.

The arc surface of the door includes a guide recess formed at a predetermined length in a width direction of the door and the arc surface of the control panel includes a stopper which protrudes toward the guide recess to be selectively locked by end walls of the guide recess corresponding to the opening angle of the door, such that a swing angle of the control panel is restricted by a predetermined range.

According to another aspect of the present invention, the control panel includes a plane and an arc surface to connect lateral ends of the plane and an upper side of the door is formed by a concave arc surface corresponding to the arc surface of the control panel, such that the arc surface of the control panel swings along the arc surface of the door.

Each of the hinge shafts is positioned adjacent to a center of the plane of the control panel, and the weight is positioned adjacent to a center of the arc surface.

It is another aspect of the present invention to provide a dish washing machine including a housing having an opening formed in a front side thereof, a door hinged to a lower end of the housing to open and close the opening, and a control panel oblique to an upper side of the door to swing with respect to the door.

The control panel swings by which hinge shafts installed to an upper side of the control panel are inserted into hinge holes formed in the door and a weight as a center of gravity of the control panel is installed in a lower side of the control panel such that the control panel is disposed at a predetermined oblique angle regardless of the opening angle of the door.

An upper side of the door includes a guide recess formed at a predetermined length in a width direction of the door and the control panel includes a stopper at a lower side thereof, which protrudes toward the guide recess to be selectively locked by the end walls of the guide recess corresponding to the opening angle of the door, so that a swing angle of the control panel is restricted by a predetermined range.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a sectional view schematically illustrating a dish washing machine including a control panel according a first embodiment of the present invention;

FIG. 2 is a view illustrating a control panel of the dish washing machine shown in FIG. 1, according to the first embodiment of the present invention, obliquely installed to the upper side of a door;

FIG. 3 is a view illustrating the control panel shown in FIG. 2, according to the first embodiment of the present invention hidden in a housing of the dish washing machine when the door is closed;

FIG. 4 is a view illustrating the control panel according to the first embodiment of the present invention exposed over the housing of the dish washing machine, when the door is opened by a predetermined angle;

FIG. 5 is a perspective view illustrating a control panel according to a second embodiment of the present invention installed to the upper side of a door;

FIGS. 6A to 6C are sectional views taken along the line A-A in FIG. 5, in which:

FIG. 6A illustrates the control panel restricted to pivot by a stopper at a first position when the door is vertically disposed;

FIG. 6B illustrates the control panel positioned at a pivotable position during the opening and closing of the door; and

FIG. 6C illustrates the control panel restricted to pivot by the stopper at a second position when the door is opened by a predetermined angle; and

FIG. 7 is a sectional view corresponding to FIG. 6C and illustrating a door, in which a control panel, according to a third embodiment of the present invention, is installed and vertically disposed.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

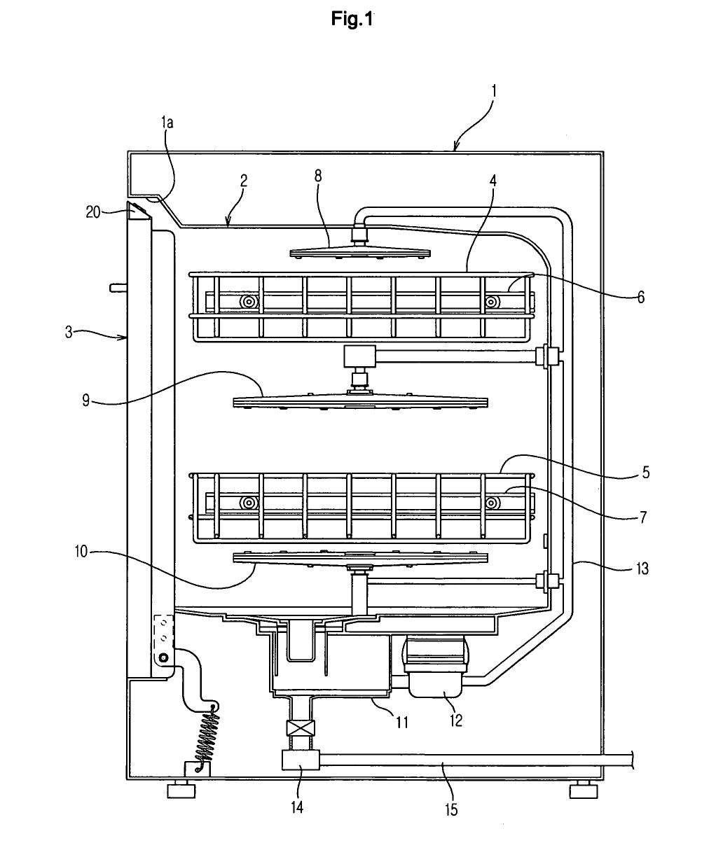

FIG. 1 is a sectional view schematically illustrating a dish washing machine including a control panel according a first embodiment of the present invention. In FIG. 1, the dish washing machine according to this embodiment of the present invention comprises a housing 1 having an opening 1a formed in a front side thereof, a front-opened tub 2 disposed in the housing 1, and a door 3 hinged to a lower side of the housing 1 to open and close opened front sides of the housing 1 and the tub 2.

In the tub 2, dish baskets 4 and 5 are installed to slide on guide rails 6 and 7 which are respectively installed to lateral upper and lower sides of the tub 2, and plurality of jet nozzles 8, 9, and 10 are installed to jet high pressure washing water to dishes accommodated in the dish baskets 4 and 5 to wash the dishes.

In an outer lower side of the tub 2, a sump 11 for collecting the washing water and dirt, a washing pump 12 for pumping the washing water collected in the sump 11 to the respective jet nozzles 8, 9, and 10 through a washing water pipe 13, and an exhaust pump 14 and an exhaust hose for exhausting the washing water containing the dirt collected in the sump 11 out of the housing 1 are installed.

On the upper side of the door 3, a control panel 20 is downwardly oblique in the housing 1 or directed toward the tub 2 such that washing time, washing course, or the like are inputted to automatically wash the dishes.

Thus, when the door 3 is opened to put dishes to be washed into the dish baskets 4 and 5 and the door 3 is closed again after input of the washing time and the washing course, the tub 2 is filled with the washing water to a predetermined level and the washing pump 12 is driven.

Due to the operation of the washing pump 12, the washing water in the sump 11 is pumped to the jet nozzles 8, 9, and 10 along the washing water pipe 13 and jetted from the jet nozzles 8, 9, and 10 to the dishes accommodated in the dish baskets 4 and 5 so that the dishes are washed.

When the washing of the dishes is finished, the exhaust pump 14 is driven to exhaust the washing water containing dirt collected in the sump 11 out of the housing 1 through the exhaust hose 15 so that the washing of the dishes are completed.

Next, the control panel according to the first embodiment of the present invention will be described in detail with reference to FIG. 24.

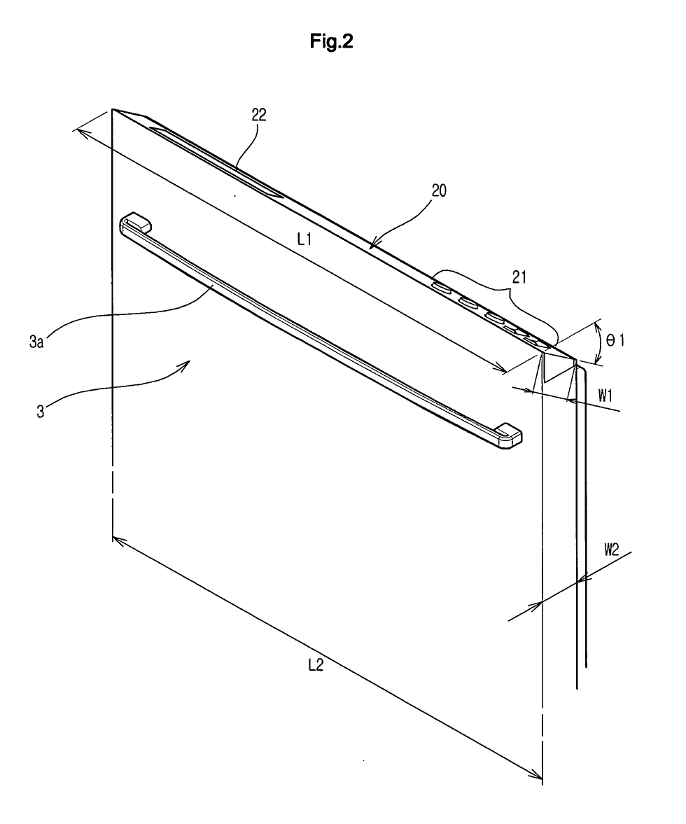

FIG. 2 is a view illustrating the control panel of the dish washing machine shown in FIG. 1, according to the first embodiment of the present invention, obliquely installed to the upper side of a door. As shown in FIG. 2, the control panel 20 comprises a manipulation unit 21 having various manipulation buttons arranged to manipulate an operation and washing courses of the dish washing machine, and a display 22 for indicating inputted information such as the washing courses, the washing time, and the like to a user.

The control panel 20 is downwardly oblique from an upper side of the door 3 toward the inside of the housing 1 such that a length L1 of the control panel 20 is identical to a length L2 of the door 3 and a width W1 (i.e., an inclined slope) of the control panel 20 is greater than a width W2 (i.e., a lateral width) of the door 3.

Thus, since areas of the manipulation unit 21 and the display 22 can be increased as the width W1 of the control panel is increased, additional manipulation buttons can be provided in the manipulation unit 21 and the display 22 can display more much information.

In order to increase a size or an area of the control panel 20, the oblique angle θ1 of the control panel 20 must be increased as much as possible. However, if the oblique angle θ1 is too large, the opening angle of the door 3 must be increased to manipulate the manipulation unit 21 and to check the display 22. Thus, in order to arrange the control panel 20 at an adequate angle, the oblique angle θ1 of the control panel 20 ranges from 5 degrees to 30 degrees, for example.

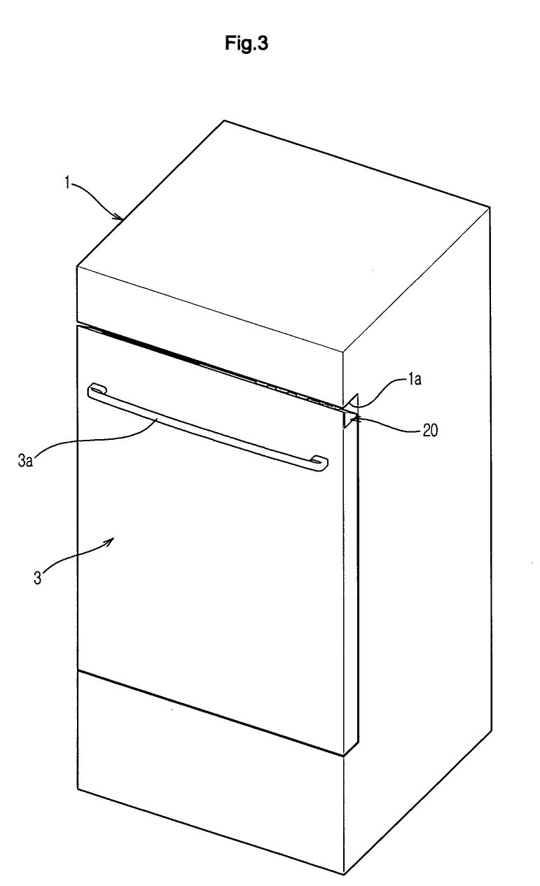

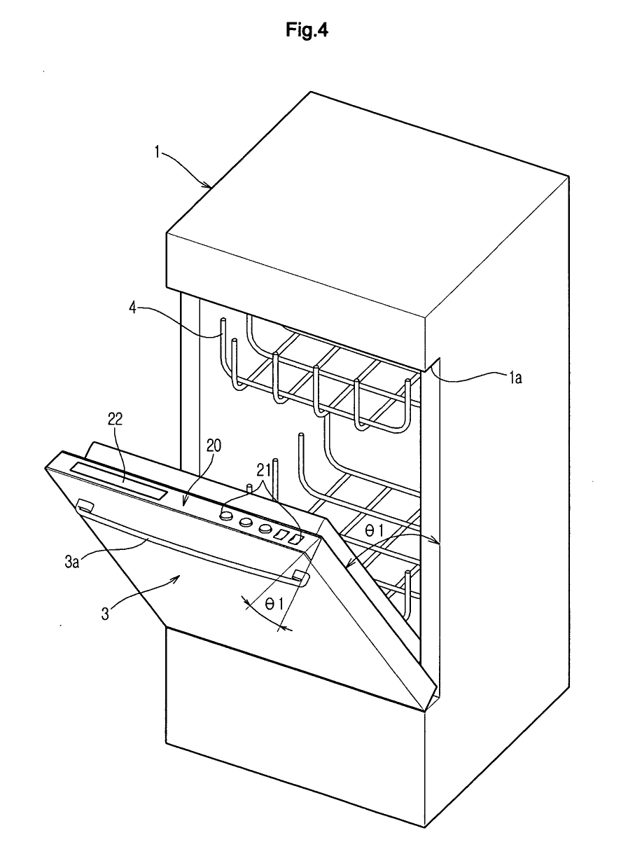

FIG. 3 is a view illustrating the control panel shown in FIG. 2, according to the first embodiment of the present invention hidden in the housing of the dish washing machine when the door is closed, and FIG. 4 is a view illustrating the control panel according to the first embodiment of the present invention exposed over the housing of the dish washing machine when the door is opened by a predetermined angle.

As shown in FIG. 3, since the control panel 20 according to the first embodiment of the present invention is installed to the upper side of the door 3, when the door 3 is closed to close the opening 1a of the housing 1, the control panel 20 is hidden in the opening 1a so that the control panel 20 cannot be seen in front of the housing 1 and an aesthetically pleasing appearance of the dish washing machine can be provided.

Therefore, when the control panel 20 is positioned to be hidden in the opening 1a of the housing 1, the display 22 of the control panel 20 is turned off to prevent undesired power consumption.

An additional display (not shown) may be installed to the front side of the door 3 or the front side of the housing 1 to indicate the present operation state and operational error of the dish washing machine to the user so that the user can check the operation state and the operational error of the dish washing machine even when the door 3 is closed.

As shown in FIG. 4, when in order to operate the dish washing machine to wash the dishes, the user grasps a handle 3a of the door 3 and pulls down the door 3 to open at an angle corresponding to the oblique angle θ1 of the control panel 20, the control panel 20, which is obliquely installed to the upper side of the door 3 by the predetermined angle θ1, is positioned horizontally.

Here, since the door 3 has a structure for fixing the door 3 to a user's desired opening angle, the door 3 is easily opened by the angle corresponding to the oblique angle θ1 of the control panel 20 and the opening position is fixed.

Therefore, when the control panel 20 obliquely installed to the upper side of the door 3 at the oblique angle θ1 is horizontally positioned due to the opening of the door 3, the user can easily manipulate the various manipulation buttons arranged in the manipulation unit 21 and easily check letters or pictures displayed on the display 22.

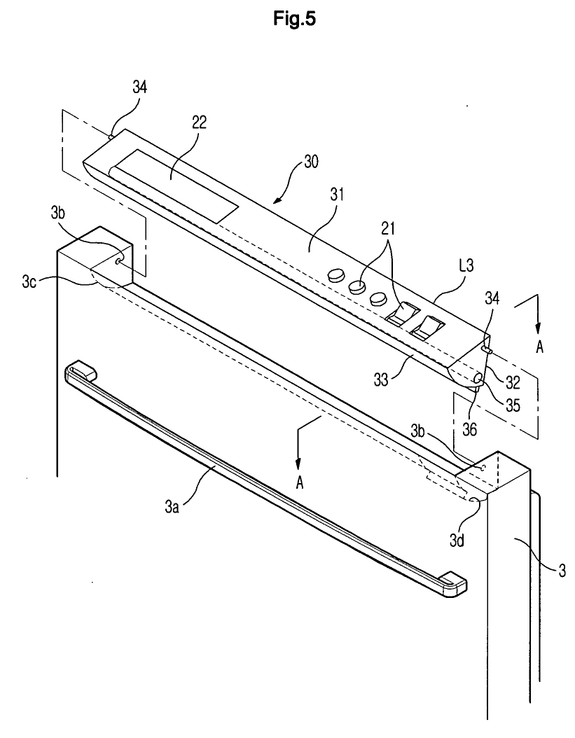

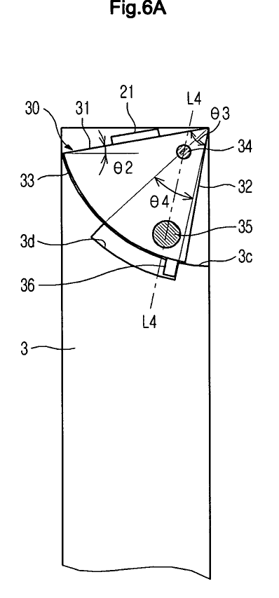

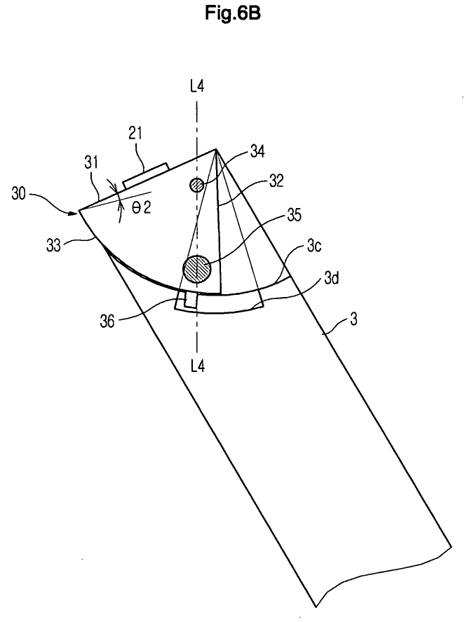

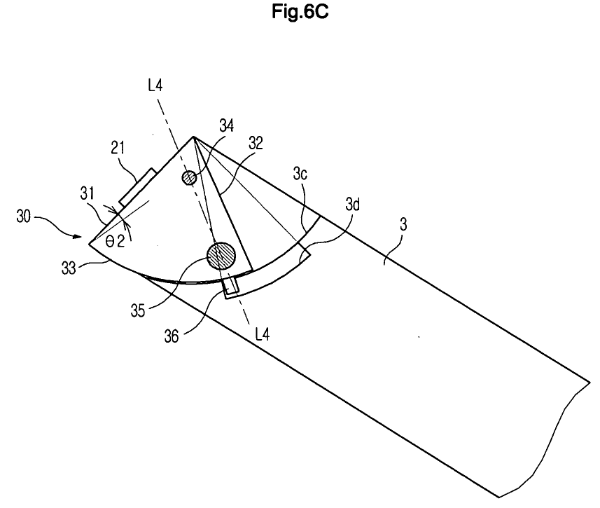

Next, a control panel according to a second embodiment of the present invention will be described with reference to FIGS. 5-6.

FIG. 5 is a perspective view illustrating a control panel according to the second embodiment of the present invention installed to the upper side of the door. As shown in FIG. 5, the control panel 30 according to the second embodiment of the present invention comprises a first plane 31 as the upper side (or the front side) of the control panel 30, a second plane 32 as the lower side (or the rear side) of the control panel 30, and an arc surface 33 for connecting the first plane 31 to the second plane 32.

The control panel 30 comprises a section similar to a quarter circle so that a line L3 where the first plane 31 meets the second plane 32 becomes a center of the arc surface 33 (as shown in FIG. 6A, the control panel actually has an arc angle slightly smaller than 90 degrees of the quarter circle-shaped section, which will be described later).

However, the sectional shape of the control panel 30 is not limited to a quarter circle and instead may be of various sectional shapes with other arc angle.

On the first plane 31 for forming the upper side of the control panel 30, like the control panel 20 according to the first embodiment, a manipulation unit 21 having various buttons are arranged for a user to operate the dish washing machine and to select the washing courses, and a display 22 for indicating the inputted information such as the selected washing course and the washing time are disposed so that the user can operate the dish washing machine.

Hinge shafts 34 are installed to lateral upper sides of the control panel 30, and hinge holes 3b are installed to lateral upper sides of the door 3, into which the hinge shafts 34 are inserted such that the control panel 30 is swingably coupled to the door 3.

A weight 35 is installed along the longitudinal direction of the control panel 30 to a lower side of the control panel 30, to be positioned at a center of gravity of the control panel 30 such that the control panel 30 swings smoothly relative to the door 3.

That is, the hinge shafts 34, a center of rotation of the control panel 30 is positioned adjacent to a center (corresponding to the line L3) of the arc surface 33 where the first plane 31 meets the second plane 32 and the center of gravity of the control panel 30 is positioned at the weight 35 installed at the lower side of the control panel 30, wherein when the respective hinge shafts 34 of the control panel 30 are inserted into the hinge holes 3b of the door 3, a force is applied to the control panel 30 such that the line L4 for connecting the hinge shafts 34 to the weight 35 is aligned with the direction of gravity (See FIG. 6B).

A concave arc surface 3c is formed at a lower side of the hinge holes 3b at the upper side of the door 3, to correspond to the arc surface 33 of the control panel 30 such that the arc surface 33 of the control panel 30 swings along the arc surface 3c of the door 3. A gap of a predetermined distance is formed between the arc surface 33 of the control panel 30 and the arc surface 3c of the door 3 such that the control panel 30 swings smoothly.

In the arc surface 3c of the door 3, a guide recess 3d is formed by a predetermined length in a width direction (or in the thickness direction) of the door 3, and in the arc surface 33 of the control panel 30, a stopper 36 protrudes toward the guide recess 3d. The stopper 36 is selectively locked by lateral walls of the guide recess 3d corresponding to the opening angle of the door 3, to restrict the swing angle of the control panel 30 by a predetermined range.

Next, an operation of the swing of the control panel 30 together with an operation of the stopper 36 will be described with reference to FIGS. 6a to 6c.

FIGS. 6A to 6C are sectional views taken along the line A-A in FIG. 5, in which FIG. 6A illustrates the control panel restricted to swing by a stopper at a first position when the door is vertically disposed, FIG. 6B illustrates the control panel positioned at a swingable position during the opening and closing of the door, and FIG. 6C illustrates the control panel restricted to swing by the stopper at a second position when the door is opened by a predetermined angle.

As shown in FIG. 6A, since, when the door 3 is vertically erected to close the opening 1a (See FIG. 3) of the housing 1, the line L4 for connecting the hinge shafts 34, and the center of rotation, to the weight 35, the center of gravity is not aligned with the direction of gravity, a force for rotating the control panel 30 counterclockwise is applied due to the weight 35, but the stopper 36 is locked by the guide recess 3d to prevent the control panel 30 from swinging further.

In this state, the first plane 31 (i.e., the upper side) of the control panel 30 in which the manipulation unit 21 and the display 22 are arranged is obliquely disposed upwardly toward the inside of the housing 1 at a predetermined angle θ2, so that the user can conveniently manipulate the manipulation unit 21 and easily check the displayed information on the display 22 when the door 3 is opened.

To this end, an arc angle θ3 of the control panel 30 is less than 90 degrees corresponding to an angle of the oblique angle θ2 of the first plane 31. That is, this section of the control panel 30 has a size slightly less than that of the quarter circle-shaped section. Thus, when the second plane 32 of the control panel 30 protrudes inwardly at the rear side (i.e., an inside) of the door 3, the control panel 30 also comprises the quarter circle-shaped section. Additionally, if a wing of the control panel 30 can be restricted by the stopper 36, the sectional shape of the control panel 30 can be varied, as necessary.

As shown in FIG. 6B, when the door 3 is opened to manipulate the manipulation unit 21 to operate the dish washing machine, the control panel 30 swings relatively with respect to the door 3 such that the line L4 for connecting the hinge shafts 34 to the weight 35 is aligned with the direction of gravity.

Due to the swing of the control panel 30, the first plane 31 of the control panel 30 maintains a constant oblique angle regardless of the opening angle of the door 3 so that the user can easily check the display 22 and conveniently manipulate the manipulation unit 21. Although the control panel 30 swings counterclockwise when the user applies a force to manipulate the manipulation unit 21, since the control panel 30 is prevented from swinging by the stopper 36 locked by the guide recess 3d, the user can manipulate the manipulation unit 21 without difficulty.

As shown in FIG. 6C, the door 3 is further opened from the position in FIG. 6B, as shown, the stopper 36 of the control panel 30 is locked by the left wall of the guide recess 3d of the door 3 and the further swing thereof is restricted. That is, the swing range of the control panel 30 is limited to an angle θ4 between lateral walls of the guide recess 3d. Since the user opens the door 3 to manipulate the manipulation unit 21 and to check the display 22 when the door 3 is opened within 45 degrees, the angle θ4 is approximately 45 degrees.

In this state, when the door 3 is closed again, the control panel 30 swings in the opposite direction and is switched to a position as shown in FIG. 6A.

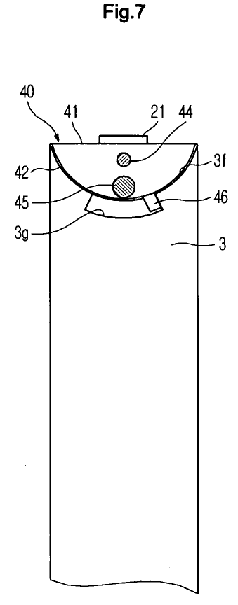

FIG. 7 is a sectional view corresponding to FIG. 6C and illustrating a door, in which a control panel according to a third embodiment of the present invention is installed, which is vertically disposed.

FIG. 7 illustrates that the control panel may have a sectional shape different from the quarter circle-shaped section in FIG. 6. In other words, the control panel 40 according to the third embodiment of the present invention comprises a semi-circular section having a single plane 41 and an arc surface 42 for connecting ends of the plane 41, and is hinged to the door 3 by hinge shafts 44 formed adjacent to the center of the plane 41.

Moreover, a weight 45 is installed near a center of the arc surface 42 such that the plane 41 faces upwardly, and a concave arc surface 3f is formed to correspond to the arc surface 42 of the door 3 such that the arc surface 42 of the control panel 40 swings along the arc surface 3f of the door 3.

Similar to the second embodiment shown in FIG. 5, in the third embodiment, the arc surface 3f of the door 3 comprises a guide recess 3g at a predetermined length in the width direction of the door 3, and the arc surface 42 of the control panel 40 is provided with a stopper 46 protruded toward the guide recess 3g.

Thus, the control panel 40 according to the third embodiment of the present invention, like the control panel 30 according to the second embodiment (see FIG. 5), is restricted to swing within a predetermined range by which the stopper 46 is locked by end walls of the guide recess 3g when the door 3 is opened.

Since the control panel 40 according to the third embodiment is almost the same as the control panel 30 according to the second embodiment except for the sectional shape thereof and operates identical to the control panel 30, the description for the overall configuration and operation thereof will be omitted.

As described above, according to an embodiment of the present invention, since the control panel is provided to the upper side of the door to be downwardly or upwardly oblique toward the inside of the housing, the size of the control panel is increased in comparison to the conventional control panel so that a wider area for the display and the manipulation unit can be secured. Since, when the door is opened by an angle corresponding to the oblique angle of the control panel, the control panel is horizontally positioned, it is convenient to manipulate the control panel and to check the operation state thereof.

In addition, according to an embodiment of the present invention, since the control panel can maintain a constant angle within a predetermined angle regardless of the opening of the door, the user can check the display and manipulate the manipulation unit more conveniently.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A dish washing machine comprising:
a housing having an opening formed in the front side thereof;
a door hinged to a front side of the housing to open and close the opening; and
a control panel installed to an upper side of the door, the control panel obliquely installed to the upper side of the door at a predetermined angle.

2. The dish washing machine according to claim 1, wherein the control panel is downwardly oblique toward an inside of the housing.

3. The dish washing machine according to claim 1, wherein the control panel is upwardly oblique to an inside of the housing.

4. The dish washing machine according to claim 3, wherein the control panel comprises hinge shafts formed in lateral upper sides of the control panel to be inserted into hinge holes formed in lateral sides of the door, to thereby enable the control panel to be swingably coupled with the door.

5. The dish washing machine according to claim 4, further comprising a weight installed in a lower side of the control panel to be a center of gravity of the control panel and to allow the control panel to swing smoothly.

6. The dish washing machine according to claim 5, wherein the control panel comprises:
first and second planes which meet at respective centers thereof, and an arc surface to connect the first and second planes to each other; and
the door comprises a concave arc surface at an upper side thereof, corresponding to the arc surface of the control panel, wherein the arc surface of the control panel swings along the arc surface of the door.

7. The dish washing machine according to claim 6, wherein each of the hinge shafts is positioned adjacent to a center of the arc surface where the first and second planes meet and the weight is positioned adjacent the second plane positioned in the door so that the first plane maintains a state oblique at a predetermined angle regardless of an opening angle of the door.

8. The dish washing machine according to claim 7, wherein the arc surface of the door comprises a guide recess formed at a predetermined length in a width direction of the door; and
the arc surface of the control panel comprises a stopper which protrudes toward the guide recess to be selectively locked by end walls of the guide recess, corresponding to the opening angle of the door, wherein a swing angle of the control panel is restricted by a predetermined range.

9. The dish washing machine according to claim 5, wherein the control panel comprises a single plane and an arc surface to connect lateral ends of the single plane and the door comprises a concave arc surface at the upper side thereof, corresponding to the arc surface of the control panel, wherein the arc surface of the control panel swings along the arc surface of the door.

10. The dish washing machine according to claim 9, wherein each of the hinge shafts is positioned adjacent to a center of the single plane of the control panel, and the weight is positioned adjacent to a center of the arc surface.

11. The dish washing machine according to claim 10, wherein the arc surface of the door comprises a guide recess formed at a predetermined length in a width direction of the door; and
the arc surface of the control panel comprises a stopper which protrudes toward the guide recess to be selectively locked by the end walls of the guide recess, corresponding to the opening angle of the door, wherein a swing angle of the control panel is restricted by a predetermined range.

12. A dish washing machine comprising:
a housing having an opening formed in the front side thereof;
a door hinged to a lower end of the housing to open and close the opening; and
a control panel obliquely formed to an upper side of the door to swing with respect to the door.

13. The dish washing machine according to claim 12, wherein the control panel comprises hinge shafts installed to an upper side of the control panel to be inserted into hinge holes formed in the door and a weight as a center of gravity which is installed in a lower side of the control panel such that the control panel is disposed at a predetermined oblique angle regardless of the opening angle of the door.

14. The dish washing machine according to claim 13, wherein the door comprises a guide recess at the upper side of the door, which is formed at a predetermined length in a width direction of the door; and
the control panel comprises a stopper at a lower side thereof, which protrudes toward the guide recess to be selectively locked by end walls of the guide recess, corresponding to the opening angle of the door, wherein a swing angle of the control panel is restricted by a predetermined range.

15. The dish washing machine according to claim 1, wherein the control panel is positioned to be hidden in the opening of the housing, when the door is closed.

16. The dish washing machine according to claim 2, wherein an inclined slope of the control panel is greater than a lateral width of the door.

17. The dish washing machine according to claim 7, wherein the first plane of the control panel comprises a manipulation unit and display to allow a user to operate the dish washing machine, and the first plane of the control panel is obliquely disposed upwardly toward an inside of the housing at a predetermined angle.

18. The dish washing machine according to claim 8, wherein a gap of a predetermined distance is formed between the arc surface of the control panel and the arc surface of the door such that the control panel swings smoothly.
